(19) United States
(12) Patent Application Publication
(10) Pub. No.: US 2025/0373906 A1
(43) Pub. Date: Dec. 4, 2025

(54) DEVICES, SYSTEMS, AND METHODS FOR STREAM MANAGEMENT IN HOSPITABILITY ENVIRONMENTS

(71) Applicant: Sonifi Solutions, Inc., Sioux Falls, SD (US)

(72) Inventors: Leon P. Stoel, Sioux Falls, SD (US); Joshua H. Pulford, Sioux Falls, SD (US); Eric Aasen, Sioux Falls, SD (US); Kara Heermans, Beresford, SD (US)

(73) Assignee: Sonifi Solutions, Inc., Sioux Falls, SD (US)

(21) Appl. No.: 18/733,389

(22) Filed: Jun. 4, 2024

(51) Int. Cl. H04N 21/6405; H04N 21/414; H04N 21/462; H04N 21/472

(52) U.S. Cl. CPC H04N 21/6405; H04N 21/414; H04N 21/4621; H04N 21/472

(57) ABSTRACT

A system for a hospitality environment includes a plurality of destination devices and a first routing device in communication with the plurality of destination devices. The first routing device may receive a request for a content stream from a first destination device of the plurality of destination devices, and determine whether the content stream is currently being provided by the first routing device to a second destination device of the plurality of destination devices. When the content stream is currently being provided by the first routing device to the second destination device, the first routing device sends the content stream to the first destination device and the second destination device, and when the content stream is not currently being provided by the first routing device to the second destination device, the first routing device forwards the request for the content stream to a first network element.

### FIELD

Example embodiments are generally directed to devices, systems, and methods for stream management in hospitality environments.

### BACKGROUND

Hospitality environments, such as hotels and hospitals, may offer in-room entertainment services to guests, which may include linear television programming, on-demand television programming, streaming, games, music, and/or the like. However, offering these entertainment services presents various challenges, many of which are unique to the hospitality environment due to the nature of providing a seamless guest experience with limited network resources.

### SUMMARY

Example aspects of the present disclosure include a system for a hospitality environment includes a plurality of destination devices and a first routing device in communication with the plurality of destination devices. The first routing device may receive a request for a content stream from a first destination device of the plurality of destination devices, and determine whether the content stream is currently being provided by the first routing device to a second destination device of the plurality of destination devices. When the content stream is currently being provided by the first routing device to the second destination device, the first routing device sends the content stream to the first destination device and the second destination device, and when the content stream is not currently being provided by the first routing device to the second destination device, the first routing device forwards the request for the content stream to a first network element.

Example aspects of the present disclosure include a device for managing content streams, comprising memory including instructions and a processor that executes the instructions to receive a single copy of a content stream from a content source, the single copy of the content stream having a first bitrate, receive a request from a destination device for the content stream, send the content stream to the destination device at the first bitrate, send, in response to receiving the request from the destination device for the content stream, a request to the content source to change the first bit rate to a second bitrate greater than the first bitrate, receive, from the content source, an updated version of the single copy of the content stream that has the second bitrate, and send the content stream to the destination device at the second bitrate.

Example aspects of the present disclosure include a device for managing content streams including memory including instructions and a processor that executes the instructions to receive a single copy of a content stream from a content source, receive requests from the plurality of destination devices for the content stream, and route the content stream to the plurality of destination devices according to the requests.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

It is to be appreciated that any feature described herein can be claimed in combination with any other feature(s) as described herein, regardless of whether the features come from the same described embodiment.

The details of one or more aspects of the disclosure are set forth in the accompanying drawings and the description below. Other features, objects, and advantages of the techniques described in this disclosure will be apparent from the description and drawings, and from the claims.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X1-Xn, Y1-Ym, and Z1-Zo, the phrase is intended to refer to a single element selected from X, Y, and Z, a combination of elements selected from the same class (e.g., X1 and X2) as well as a combination of elements selected from two or more classes (e.g., Y1 and Zo).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages of the present disclosure will become apparent to those skilled in the art upon consideration of the embodiment descriptions provided hereinbelow.

Additional features and advantages of embodiments of the present disclosure will become more readily apparent from the following description, particularly when taken together with the company drawings.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 illustrates a system for stream management according to at least one example embodiment.

FIG. 2 illustrates another system for stream management according to at least one example embodiment.

FIG. 3 illustrates still another system for stream management according to at least one example embodiment.

FIG. 4 illustrates yet another system for stream management according to at least one example embodiment.

FIG. 5 illustrates an environment for the systems in FIGS. 1-4 according to at least one example embodiment.

FIG. 6 illustrates a method for stream management according to at least one example embodiment.

FIG. 7 illustrates a method for bitrate management according to at least one example embodiment.

### DETAILED DESCRIPTION

Free-to-guest content streams in hospitality environments (e.g., hotels, hospitals, and the like) are currently available to guests and are typically present at the environment even when not in use by guests. Guest preferences, however, are trending toward more personalized per-user content streaming which significantly increases the number of incoming content streams and requires the hospitality property to invest in high bandwidth Internet service and network components to ensure that the property is capable of receiving and distributing the increased number content streams. Thus, per-user content streaming in a hospitality environment increases cost to the property manager and may result in large quantities of unused bandwidth during low traffic periods.

Inventive concepts propose to address the above technical problems and other problems in the field by providing systems and methods for managing content streams in a manner that enables low-cost and resource-efficient streaming on a per-user (or per-guestroom) basis. For example, a system according to example embodiments may include a device (referred to as a stream manager) that is on-site or remote from a hotel and that converts a content stream that is normally provided to users within the hotel on a per-user basis into a broadcast or multicast content stream that is capable of being provided to multiple users within the hotel simultaneously. The stream manager according to example embodiments may be considered an “edge” routing device on the hotel's network that exists between user devices within the hotel and sources of content streams. Requests for content streams and the content streams themselves flow through the stream manager, which enables the stream manager to determine whether a content stream identified by a new request is already being provided to another user within the hotel. If true, the stream manager routes a copy of the content stream already being provided to the other user to the user that submitted the new request without retrieving a new version of the same content stream from the source, which avoids using network resources that would otherwise be required to retrieve the new version of the content stream. In this way, a hotel may achieve per-user streaming with fewer network resources, thereby achieving an improved guest experience without increased costs.

It should be understood that various aspects disclosed herein may be combined in different combinations than the combinations specifically presented in the description and accompanying drawings. It should also be understood that, depending on the example or embodiment, certain acts or events of any of the processes or methods described herein may be performed in a different sequence, and/or may be added, merged, or left out altogether (e.g., all described acts or events may not be necessary to carry out the disclosed techniques according to different embodiments of the present disclosure). In addition, while certain aspects of this disclosure are described as being performed by a single module or unit for purposes of clarity, it should be understood that the techniques of this disclosure may be performed by a combination of units or modules associated with, for example, a computing device.

In one or more examples, the described methods, processes, and techniques may be implemented in hardware, software, firmware, or any combination thereof. If implemented in software, the functions may be stored as one or more instructions or code on a computer-readable medium and executed by a hardware-based processing unit. Alternatively or additionally, functions may be implemented using machine learning models, neural networks, artificial neural networks, or combinations thereof (alone or in combination with instructions). Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors (e.g., Intel Core i3, i5, i7, or i9 processors; Intel Celeron processors; Intel Xeon processors; Intel Pentium processors; AMD Ryzen processors; AMD Athlon processors; AMD Phenom processors; Apple A10 or 10X Fusion processors; Apple A11, A12, A12X, A12Z, or A13 Bionic processors; or any other general purpose microprocessors), graphics processing units (e.g., Nvidia Geforce RTX 2000-series processors, Nvidia Geforce RTX 3000-series processors, AMD Radeon RX 5000-series processors, AMD Radeon RX 6000-series processors, or any other graphics processing units), application specific integrated circuits (ASICs), field programmable gate arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

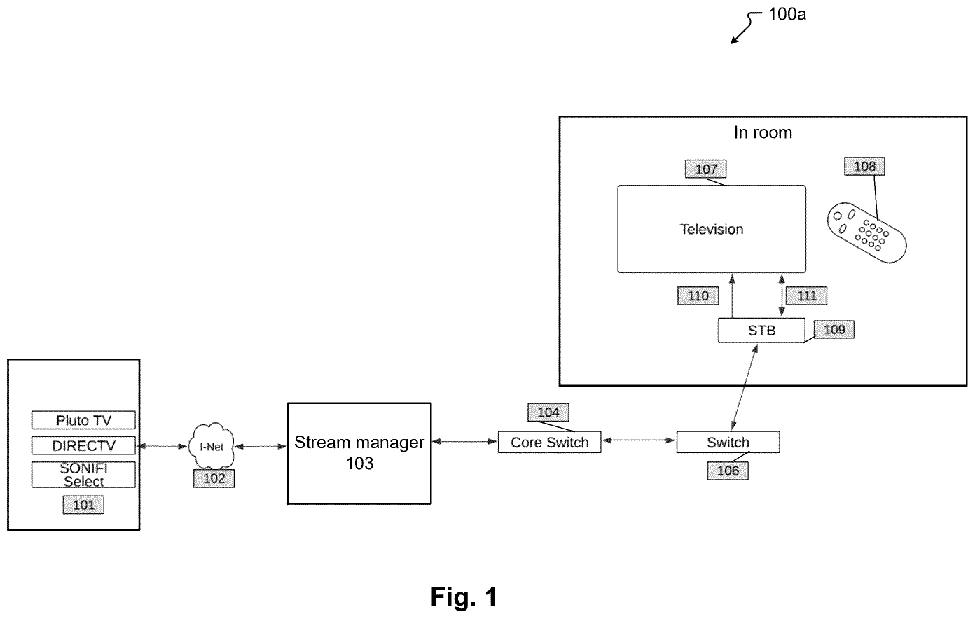

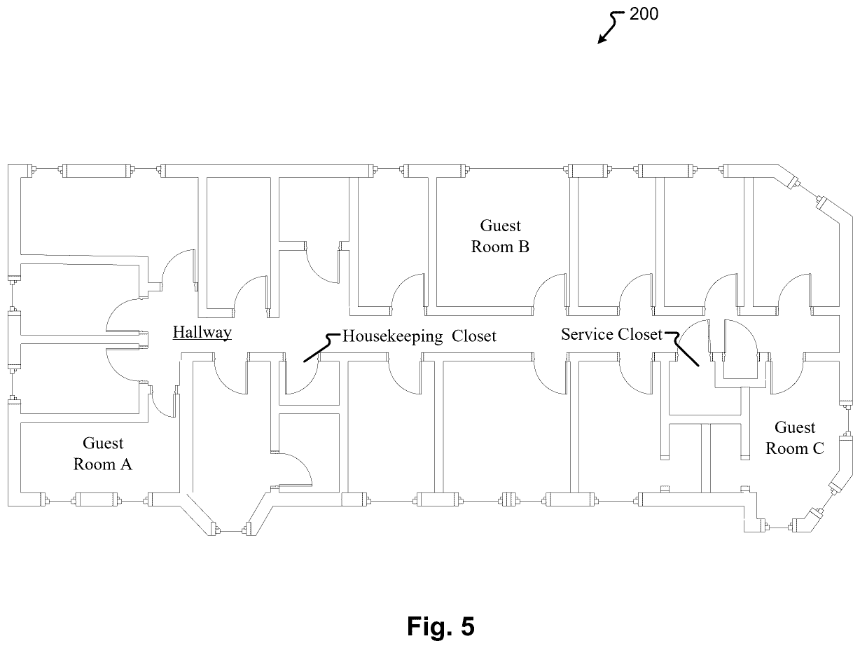

FIG. 1 illustrates a system 100a according to at least one example embodiment. As may be appreciated, the system 100a implements Internet Protocol (IP) components and a set top box (STB) for use in accordance with example embodiments. The system 100a may include one or more content sources 101, the Internet 102, a stream manager 103, a core switch 104, one or more switches 106, a television 107, a remote control 108, and an STB 109. The system 100a may provide entertainment services to a hospitality environment 200 illustrated in FIG. 5. In this example, the TV 107, remote control 108, and STB 109 may be located within a single guestroom while switches 104 and 106 are located in other areas of the environment 200, such as in service closets. The stream manager 103 may also be located within the environment 200, such as at an edge of the environment's local network. However, the stream manager 103 may also be remote to the environment 200, such as a remotely implemented cloud server, while still functioning as an edge-device for the environment 200.

Content sources 101 may comprise one or more servers, operated by a content provider (e.g., PLUTO TV, DIRECTV, SONIFI SELECT, etc.), that provide end-user audio and/or video content to devices within the environment, such as the TVs 107. In at least one embodiment, a content source 101 controls access to entertainment options for users within the environment 200. Such entertainment options include but are not limited to viewing of live television programming, video on demand, room service, video games, and/or the like, all of which may be presented on a TV 107. Thus, a content source 101 may be installed and/or controlled by an entity (e.g., a property manager of environment 200) that enables the entertainment options and controls user access to such options. In some examples, the content sources 101 provide free-to-guest services available to all guestrooms within the environment 200 at no charge (i.e., the services are not subscription based). Accordingly, a user in each guestroom need not authenticate with a particular content source 101 to receive the content. In other examples, the content sources 101 also include subscription-based providers, such as NETFLIX, APPLE TV, etc., which may require each guest to provide credentials (e.g., username and password) in order to access content.

As described in more detail herein, the stream manager 103 manages content received from content sources 101 on behalf of the environment 200, and thus has processing and network traffic routing capabilities. For example, the stream manager 103 may receive a single copy of a content stream from a content source 101, receive requests from a plurality of destination devices (e.g., TVs 107) for the content stream, and then route the content stream to the plurality of destination devices according to the requests. These operations are described in more detail below with reference to FIGS. 1-7 but in general, the stream manager 103 may ensure that the local network within an environment 200 utilizes a single copy of a content stream from a content source 101 even if multiple TVs 107 are viewing the same content stream. If a TV 107 requests (e.g., through user input to remote control 108) one of the streams already being provided by the stream manager 103 to one or more other TVs 107, the stream manager 103 may send the requested stream to the new user's TV 107 without requesting a duplicate of the same stream from the content source 101, thus reducing the amount of bandwidth required at the edge of the environment's local network. If a particular content stream is not currently being viewed/consumed by a user within the environment 200, the stream manager 103 may detect this and terminate the connection to the content source 101 for that content stream to save bandwidth.

Free-to-guest services are well suited for being managed by the systems and methods described herein because such services do not generally require individual user credentials to gain access to the services. However, it should be appreciated that such free-to-guest services may still require the stream manager 103 to authenticate with the content sources 101 as a device that is authorized to retrieve a particular content stream. Here, the stream manager 103 may provide a content source 101 with an identifier (e.g., unique identifier) that is associated with a particular environment 200 so that the content source 101 can validate that environment 200 as one that is authorized to receive a particular content stream or set of content streams.

Still with reference to FIG. 1, content sources 101 are connected to the stream manager 103 through the Internet 102 or other suitable network. The stream manager 103 may be in communication with the TV 107 through the core switch 104, one or more switches 106, and STB 109. The system 100a may employ Internet Protocol (IP) communication between the content sources 101, the stream manager 103, the switches 104/106, and the STB 109. Meanwhile, the STB 109 may be connected to the TV 107 by one or more connection interfaces, such as an HDMI connection, MTI connection, MPI connection, IP connection, and/or RS232 connection. The STB 109 and/or the TV 107 may receive wireless commands from remote control 108. In some examples, the remote control 108 uses infrared signals to send commands and is implemented as a TV remote control. In other examples, the remote control 108 is implemented with a user interface on a mobile device, such as a smartphone or tablet that has been paired with the network of the environment 200 (e.g., paired with the stream manager 103 according to suitable pairing protocols associated with a STAYCAST® system).

The TV 107 may comprise suitable hardware and/or software and processing capability for reproducing audio and/or video content for consumption by a user. For example, a TV 107 may be implemented by a television (LED display, LCD, etc.), a computer monitor, a tablet, a projector, and/or other device suitable for reproducing audio and/or video content.

The switches 104 and 106 may comprise suitable hardware and/or software and processing capability for routing signals (e.g., content streams, commands, etc.) to/from TVs 107. A switch 104 and/or 106 may correspond to a routing device described herein. The switches 104 and 106 may enable wired communication (e.g., IP communication) between elements of the system 100, and as such, may comprise a network switch, such as an Ethernet switch or the like. The core switch 104 may be distinguished from switch(es) 106 in that the core switch 104 is the first routing device encountered by traffic output from the stream manager 103 while one or more switches 106 are downstream of and connected to the core switch 104. As may be appreciated, more or fewer switches 104 and 106 may exist within the system 100a.

As described in more detail below, the stream manager 103 manages content received from content sources 101 on behalf of the environment 200. In some examples, the stream manager 103 is an edge device of the environment 200 that is positioned between the content sources 101 and the local network of the environment 200. In at least one embodiment, the stream manager 103 is aware of which content streams from content sources 101 are already being received by devices (e.g., TVs 107) within the environment 200 and distributes these existing content streams on an as-needed basis to other devices (e.g., TVs 107) that later request to receive those content streams.

By way of example, assume a first user tunes their TV 107 (e.g., selects a channel through the remote control 108) to a content stream not yet in use by other TVs 107 in the environment 200. In this case, the stream manager 103 determines that the content stream is not currently being distributed to any other TVs 107 and requests the content stream from an appropriate content source 101 and then provides the content stream to the first user's TV 107. Then, while the first user's TV is still tuned to that content stream, a second user in a different guestroom requests the same content stream to be provided to their TV 107. In this case, the stream manager 103 receives the request and determines that the content stream requested by the second user is already being provided to the first user's TV 107 and proceeds to provide that content stream to the second user's TV 107 using the same copy of the content stream from the content source 101 that is already being provided to the first user's TV 107. For example, the stream manager 103 creates a multicast transmission that sends the same content stream to both TVs 107. Specifically, the stream manager 103 may add a network address associated with the requesting TV 107, such as an IP address of the TV 107 itself if the TV 107 is an IPTV (see system 100b) or an IP address of the STB 109, to a multicast transmission of the already present content stream.

The above-described method of content distribution to devices in environment 200 may reduce the amount of bandwidth required at the edge of the environment 200 compared to related art techniques. For example, the stream manager 103 may ensure that only one copy of each content stream being used within the environment 200 is retrieved from the content sources 101, and thus, the bandwidth required at the edge of the environment 200 may be reduced compared to related art systems where the second user's request for the same content stream being viewed by the first user results in retrieval of another copy of that content stream from the content source 101. In some examples, the stream manager 103 maintains a single copy of only those content streams in use within the environment 200 so that edge bandwidth is not used on unrequested content streams. In other examples, the stream manager 103 maintains (e.g., constantly receives) a single copy of all possible content streams from content source(s) 101 even if all streams are not concurrently requested by users within the environment 200. Although this implementation may consume more bandwidth than maintaining only those content streams which are in use, latencies associated with retrieving a newly requested content stream may be reduced, thus improving the user experience. For example, picture delays may be avoided when changing channels (content streams) because the stream manager 103 need not request an inactive content stream from a content source 101. In some examples, the stream manager 103 manages bitrates of incoming and distributed content streams.

In any event, systems and methods according to example embodiments may enable the environment 200 to predict the amount bandwidth needed to provide free-to-guest streaming services, thereby avoiding costs associated with subscribing to a high-bandwidth plan from an Internet provider that may go unused for large chunks of time. For example, the amount of edge bandwidth needed by the environment 200 may be determined based on the maximum number of content streams that could be in use within the environment 200. In example embodiments, the maximum required edge bandwidth may be determined by the number of content streams made available to users within the environment 200. Meanwhile, the maximum required edge bandwidth of related art systems may be determined by the number of devices within the environment 200 that are capable of receiving the content streams, which is often a much larger number than the number of available content streams. For example, in the related art, a 100 room property with a TV 107 in each room that has access to 50 content streams may require the property manager to maintain hardware and services that achieve an edge bandwidth which is capable of handling 100 content streams simultaneously in a scenario where every TV 107 in every room is tuned to a content stream. For the same scenario in the same 100 room property, however, implementing systems and methods according to example embodiments may utilize an edge bandwidth capable of handling 50 content streams, which enables the property manager to use less expensive equipment and services to achieve the same outcome as the related art.

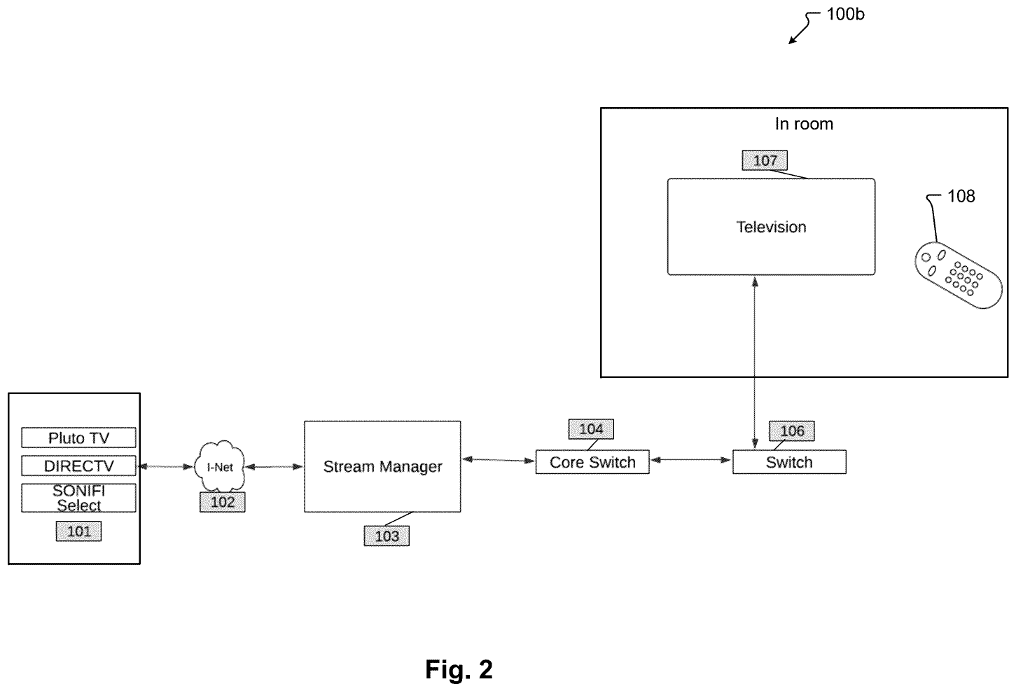

FIG. 2 illustrates a system 100b according to at least one example embodiment. The system 100b includes the same elements as system 100a in FIG. 1 except that system 100b excludes the STB 109 because the TV 107 is an IPTV capable of communicating with switch 106 according to IP standards.

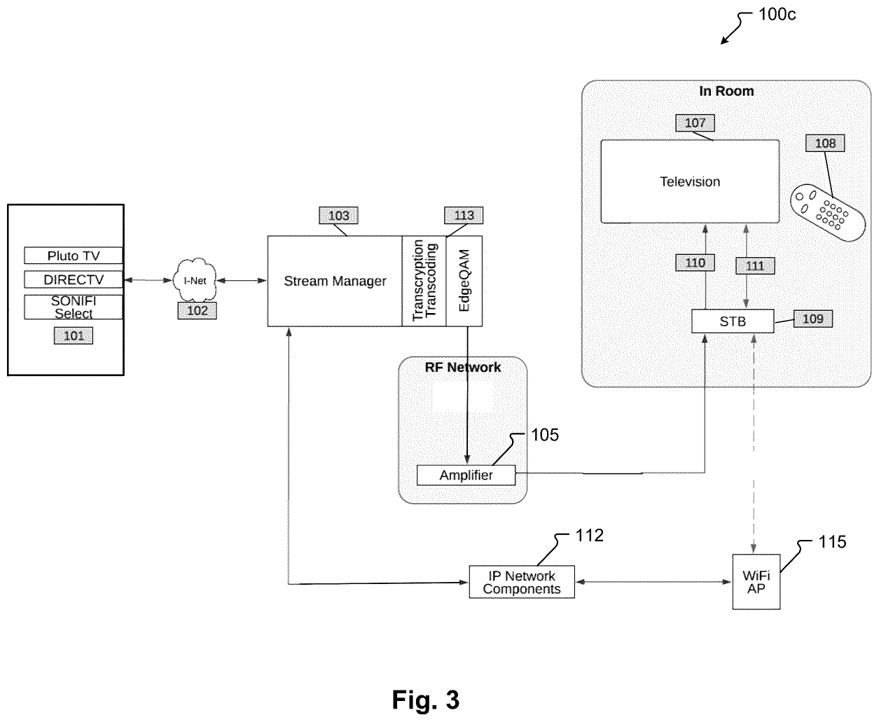

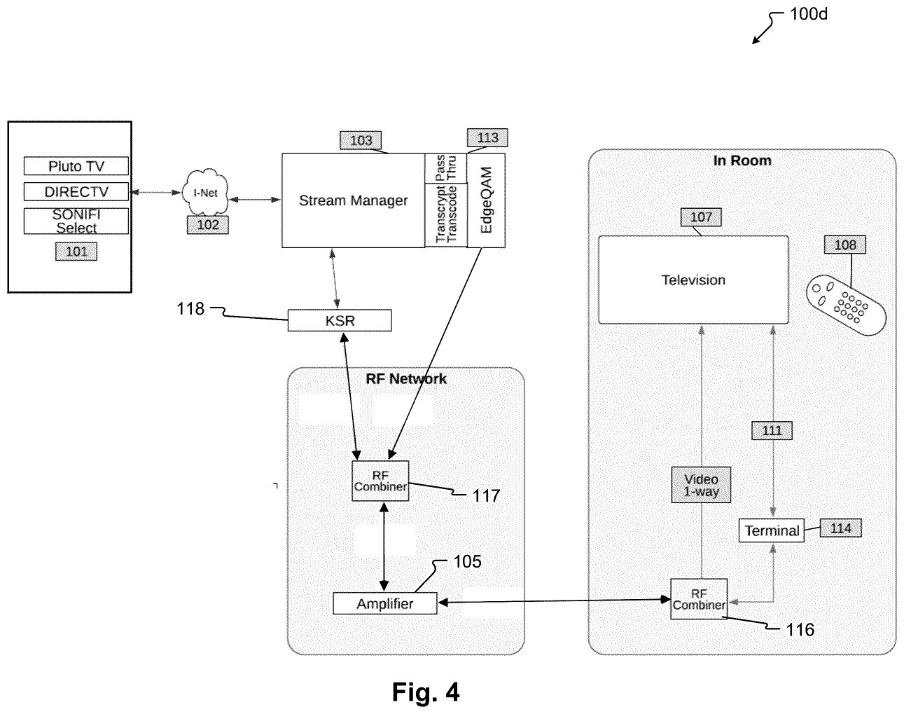

FIGS. 3 and 4 illustrate systems 100c and 100d according to at least one example embodiment. As may be appreciated, systems 100c and 100d comprise a combination of radio frequency (RF) components and IP components whereas systems 100a and 100b comprise primarily IP components. FIGS. 3 and 4 illustrate some of the same elements as FIGS. 1 and 2, and as such, a description of these elements is not repeated.

With reference to FIG. 3, system 100c comprises one or more components capable of RF communication over, for example, a coaxial cable. Such components include the converter 113, amplifier 105, and the STB 109 with serial connection 111. System 100c also comprises components capable of IP communication, such as the content sources 101, internet 102, stream manager 103, IP components 112, access point (AP) 115 (e.g., a Wi-Fi router), and STB 109 capable of communicating with the AP 115. In operation, user commands to the remote control 108 may be passed through the TV 107 to the STB 109 through the serial connection 111, such as a RS232 connection or other suitable pass through connection. The STB 109 may convert the commands received over the serial connection 111 into IP signals that are then transmitted by the STB 109 to the AP 115. The STB 109 and AP 115 may communicate over a suitable wireless connection, such as Wi-Fi, or even a suitable wired connection, such as Ethernet. The AP 115 may communicate with the stream manager 103 over wireless and/or wired IP network that includes IP components 112, which may include one or more switches similar to or the same as switches 104 and 106 in FIG. 1. In at least one embodiment, user commands input to the remote control 108 are passed to the stream manager 103 through the AP 115 and IP components 112. One example of a user command is a request for a particular content stream provided by a content source 101 for display on TV 107. The stream manager 103 may receive the request, determine that the requested content stream is not yet being broadcast to other TVs 107 in the environment, and then fetch the requested content stream from a content source 101. Thereafter, the content stream is sent to the converter 113.

The converter 113 may comprise hardware and/or software used for distributing content over an RF network. The converter 113 may provide transcryption and/or transcoding functions for converting IP content streams into a format for RF transmission (e.g., over a coax cable) to an STB 109. The converter 113 may also provide modulation functionality, such as Quadrature Amplitude Modulation (QAM) to operate as an edge-QAM device. Additionally or alternatively, the converter 113 may implement frequency-shift keying (FSK) techniques. The stream manager 103 and converter 113 may be integrated with one another into a single device or exist as separate devices with a suitable connection therebetween. In some examples, upon receiving a new content stream from a content source 101, the stream manager 103 and/or the converter 113 assign a channel to the new content stream that corresponds to the channel requested by the user with the remote control 108 and outputs an RF signal according to the assigned channel. The assigned channel may also be sent by the stream manager 103 to the STB 109 via IP components 112 and AP 115. In any event, the assigned channel for a particular content stream may be the same for all TVs 107 in a particular environment 200. Thus, the RF signal output from the converter 113 may correspond to a broadcast signal carrying the requested content stream which is received and amplified by amplifier 105 before traveling onward to the STB 109. In some examples, the RF signal travels from the stream manager 103/converter 113 to the STB 109 through the amplifier over a suitable RF connection, such as a coaxial cable connection or other suitable connection (e.g., MATV). The STB 109 may receive and decrypt and/or decode the RF signal according to the assigned channel (e.g., received over IP components 112 and AP 115) for output to the TV 107 over connection 110, such as an HDMI connection.

In FIG. 3, if another TV 107 requests a content stream that is already being broadcast by stream manager 103, the channel assignment for that content stream may be sent to the requesting TV's 107 STB 109 to enable viewing of the broadcast content stream at the newly requesting TV 107. In some examples, the channel assignment for an already broadcasted content stream is sent on a by-request basis, such as in response to a TV 107 requesting that particular stream. In other examples, the channel assignment for a broadcasted content stream is sent to all STBs 109 in an environment 200 upon being retrieved from the content source 101 by the stream manager 103.

Turning to FIG. 4, system 100d illustrates another implementation involving RF components and IP components, some of which are illustrated and described above with reference to FIGS. 1-3. The RF components in system 100d may include terminal 114, RF combiners 116 and 117, and keystroke router (KSR) 118. The KSR 118 may additionally be an IP component along with stream manager 103 and content sources 101. In general, the KSR 118 converts requests and commands from one format into another format. As shown, the stream manager 103 in system 100d may include or be connected to the same or similar converter 113 from system 100c. In operation, a user request for a content stream by way of input to remote control 108 passes through the TV 107 to terminal 114 using the same or similar serial connection 111 as in system 100c. The terminal 114 may be a proprietary device (e.g., a b-LAN™ device) that enables communication between the TV 107 and an RF network (e.g., including RF components connected with coax cables). The terminal 114 may process a request for a content stream and forward the request to KSR 118 through one or more RF components, such as combiners 116 and 117 and amplifier 105. The KSR 118 may convert the received request for a content stream from an RF signal into an IP signal and send the request via an IP connection to stream manager 103. The stream manager 103 may receive the request, determine that the requested content stream is not yet being broadcast to other TVs 107 in the environment, and then fetch the requested content stream from a content source 101. Thereafter, the content stream is sent to the converter 113.

The converter 113 performs the same or similar operations as described with reference to FIG. 3 to convert the content stream (in IP format) to a format suitable for distribution on an RF network. The content stream is then broadcast to the RF network in the same manner as that described above in FIG. 3 except that the stream in FIG. 4 does not encounter an STB 109 at TV 107, and instead passes from RF combiner 116 to TV 107 via one-way audio/video connection (e.g., a coax cable).

In the event that the content stream requested by KSR 118 is already present at the stream manager 103, then system 100d may operate in the same or similar manner as described above with reference to FIG. 3 except that system 100d provides a channel assignment of the content stream to the terminal 114 instead of to STB 109, thereby enabling the requesting TV 107 to display the content stream on the assigned channel.

Here, it should be appreciated that various elements in FIGS. 1-4 (e.g., items 101, 103, 104, 105, 106, 107, 109, 112, 113, 114, and/or 115) may be implemented with or include suitable processing circuitry. Such processing circuitry may comprise software, hardware, or a combination thereof. For example, the processing circuitry may include a memory including executable instructions and a processor (e.g., a microprocessor) that executes the instructions stored on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally or alternatively, the processing circuitry may comprise hardware, such as an application specific integrated circuit (ASIC). Other non-limiting examples of the processing circuitry include an Integrated Circuit (IC) chip, a Central Processing Unit (CPU), a Graphics Processing Unit (GPU), a microprocessor, a Field Programmable Gate Array (FPGA), a collection of logic gates or transistors, resistors, capacitors, inductors, diodes, or the like. Some or all of the processing circuitry may be provided on a Printed Circuit Board (PCB) or collection of PCBs. It should be appreciated that any appropriate type of electrical component or collection of electrical components may be suitable for inclusion in the processing circuitry 128.

In addition, although not explicitly shown, it should be appreciated that the elements in FIG. 1 include appropriate communication interfaces for facilitating wired and/or wireless communication between one another and other unillustrated elements of the system.

It should be appreciated that the elements of the systems 100a-d and environment 200 are shown for the sake of explanation and that more or fewer elements may be included. In addition, one or more elements of the systema 100a-d may be integrated with one or more other elements of the systems 100a-d. For example, the STB 109 may be integrated with the TV 107 and/or the stream manager 103 may be integrated with the core switch 104 and/or downstream switches 106. For example, if a request for a content stream passes through multiple switches 104/106, each switch may contain a stream manager 103 function to determine whether the content stream is already present at the switch and, if so, perform the same or similar functions described with reference to systems 100a-d to provide the content stream from that switch to the requesting TV 107, which may eliminate the need for the request and/or the content stream to traverse the entire local network of an environment 200.

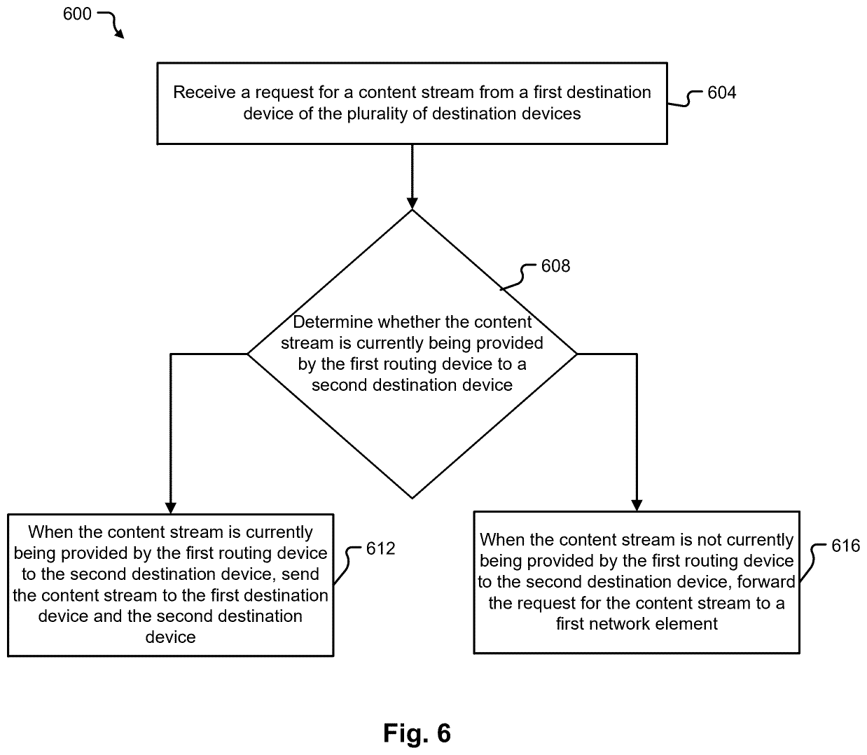

FIG. 6 illustrates a method 600 according to at least one example embodiment. Each operation in method 600 may be carried out with one or more suitable messages or signals sent over a wired and/or wireless connection by one or more elements of the systems 100a-d which may be said to include a plurality of destination devices. A “destination device” herein may correspond to a TV 107 by itself (e.g., an IP TV), a combination of TV 107 and STB 109, and/or a combination of TV 107 and terminal 114. Operations of the method 600 will now be described, first with reference to an IP system as in FIGS. 1 and 2, and then with reference to an RF system as in FIGS. 3 and 4.

Operation 604 includes receiving a request for a content stream from a first destination device of a plurality of destination devices. The requested content stream may be an audio and/or video stream (e.g., movie, TV show, video game, over-the-Internet music) made available by an environment 200 as a free-to-guest service. The request for the content stream may be received by a first routing device, which may correspond to a stream manager 103 and/or one or more switches 104, 106 depending on the system implementation. For example, in an IP system such as systems 100a-b, the first routing device corresponds to a switch 104/106 if the request must pass through such a switch when traveling between the first destination device and the stream manager 103. In some examples, the first routing device corresponds to the stream manager 103, for example, if the request does not need to traverse switches 104 and/or 106 to arrive at the stream manager 103.

Operation 608 includes determining whether the content stream requested in operation 604 is currently being provided by the first routing device to a second destination device of the plurality of destination devices. The second destination device may be any other destination device within the same environment 200 as the first destination device that is connected to the first routing device. In some examples, operation 608 includes the first routing device accessing internal memory to determine whether the requested content stream is on a list of active content streams already being provided by the first routing device to the second destination device and/or other ones of the destination devices. If so, the method proceeds to operation 612 to send the content stream to the first destination device and the second destination device. For example, the first routing device updates an internal multicast routing table to include an address associated with the first destination device, such as an IP address of the STB 109 connected to a requesting TV 107 or an IP address of the requesting TV 107 which results in the requested content stream being sent to the first destination device without interrupting the content stream already being provided to the second destination device.

If the requested content stream is not being currently provided to the second destination device in operation 608 (e.g., the requested content stream is not on the list of active streams at the first routing device), then the method 600 proceeds to operation 616 to cause the first routing device to forward the request for the content stream to another element in the local network, termed here as a first network element.

Subsequent operation 616, another iteration of the method 600 may be performed by the first network element to either cause the first network element to provide the requested content stream to the first destination device if already being provided by the first network element to another destination device or forward the request to a next (upstream) network element (e.g., a next switch 106/104, the stream manager 103, or a content source 101). In an IP system, the first network element in operation 616 may correspond to the stream manager 103, another switch 104/106, or a content source 101, depending on which of those elements is the next to encounter the request as it travels from the first destination device through the system.

In some examples, the first network element in operation 616 is at an edge of a network (e.g., an edge of the local network of the environment 200) that includes the first routing device, the second routing device, and the plurality of destination devices. In this case, the first network element may correspond to stream manager 103 to which a content source 101 provides the content stream. Thereafter, the stream manager 103 provides the content stream to the first destination device in accordance with the discussion above.

In some examples, however, the first network element corresponds to a second routing device (e.g., a switch 104 or 106) that performs another iteration of the method 600 which may include the second routing device receiving the request for the content stream from the first routing device, determining whether the content stream is currently being provided by the second routing device to a third destination device in the plurality of destination devices, and when the content stream is currently being provided by the second routing device to the third destination device, sending the content stream to the first destination device and the third destination device via multicast. When the content stream is not currently being provided by the second routing device to the third destination device, the second routing device forwards the request for the content stream to a second network element.

Continuing this example, the second network element may correspond to a content source 101 that provides the requested content stream. The request for the content stream received by the content source 101 from the second routing device may comprise credentials that are authenticated by the content source 101. The credentials may be used by the content source 101 to determine which services are available for use by different environments 200. Thus, the credentials may include information to identify the particular environment 200 that sent the request for the content stream to make sure that environment 200 is one that is authorized to receive the requested content stream.

In the above example, the first routing device and the second routing device route IP traffic. In some scenarios, the content stream sent by the second routing device to the first destination device via multicast is routed through the first routing device (e.g., another switch 106). In other scenarios, the content stream sent by the second routing device to the third destination device via multicast is not routed through the first routing device. In some examples, however, the second network element above corresponds to a third routing device, such as another switch 106/104 where another iteration of the method 600 is performed.

As may be appreciated from the description of the IP implementation thus far, the request for the content stream by the first destination device may traverse through a network of switches (if included in the environment 200), one or more of which may have the same or similar functionality as stream manager 103 to process the request and provide the requested content stream if already being provided to another destination device by the switch in question, thereby eliminating the need for the request and “copy” of the subsequent content stream to traverse the entire local network. Stated another way, an iteration of the method 600 may be performed by each switch 106/104 until the request reaches the stream manager 103 as the edge device that retrieves the content stream from the content source 101 or until the requested content stream is sent to the requesting TV 107 by one of the switches encountered by the request. However, in some embodiments, such as in IP systems that do not include switches 104/106 positioned throughout the environment 200, the method 600 may be performed entirely by the stream manager 103 to retrieve new content streams from content sources 101 and/or route existing content streams to destination devices.

Thus far, the method 600 has been primarily described as being implemented with an IP system as shown and described with reference to FIGS. 1 and 2. However, the method 600 may also apply to an RF system as shown and described with reference to FIGS. 3 and 4. With reference to the method 600 and FIGS. 3 and 4, a terminal may be collocated with the first destination device and pass the request for the content stream from the TV 107 to the first routing device. In an RF system (e.g., systems 100c-d), the first routing device may correspond to the stream manager 103. In the case of FIG. 3, the terminal may correspond to an STB 109 that processes both RF and IP signals. In this scenario, it may be said that the first routing device (stream manager 103) and the terminal (STB 109) communicate over a first network (e.g., an RF network), whereas the first routing device and the content source 101 communicate over a second network (e.g., IP network). In FIG. 3, an access point 115 may be in communication with the terminal (STB 109) and wirelessly transmit the request for the content stream to the first routing device (stream manager 103) through IP network components 112. In FIG. 4, however, the terminal corresponds to terminal 114. In any event, the request for the content stream is communicated to the first routing device (stream manager 103) through the terminal (114 or STB 109).

In an RF implementation, the first routing device, which receives the request from terminal 114 in operation 604, generally corresponds to the stream manager 103 because the systems shown in FIGS. 3 and 4 may lack a component similar to switch(es) 104/106 that could make the determination in operation 608 and perform operations 612 and 616. Stated another way, an RF network does not necessarily utilize switches or similar components that have the capability to perform operations 608, 612, and/or 616, and thus, these operations may be performed at the stream manager 103 in systems 100c-d. As may be appreciated then, the first network element in operation 616 above may correspond to a content source 101 that retrieves the requested content stream.

Referring back to the method 600 as carried out by systems 100c-d, and in particular, operations 608 and 616, the first routing device (stream manager 103) may receive the request for the content stream, determine that the requested content stream is not yet being broadcast to other TVs 107 in the environment, and then fetch the requested content stream from the first network element (a content source 101). Thereafter, the content stream is sent to the converter 113 for distribution to the RF network.

However, if the first routing device (stream manager 103) determines that the requested content stream is already being broadcast by stream manager 103 in operation 608, operation 612 may include sending the channel assignment for that content stream to the requesting TV's 107 STB 109 or terminal 114 to enable viewing of the content stream at the newly requesting TV 107. In some examples, the channel assignment for an already broadcasted stream is sent on a by-request basis, such as in response to a TV 107 requesting that particular stream. In other examples, the channel assignment for a broadcasted stream is sent to all STBs 109 or terminals 114 in an environment 200 upon being retrieved from the content source 101 by the stream manager 103.

Moving forward and as described with reference to FIGS. 3 and 4, once the content stream is fetched from a content source 101, the first routing device (stream manager 103) reformats the content stream for transmission. For example, the converter 113 reformats the content stream from IP format as received from the content source 101 to a format suitable for transmission over the RF network (e.g., QAM signal) to TV 107 in accordance with the discussion of FIGS. 3 and 4 above.

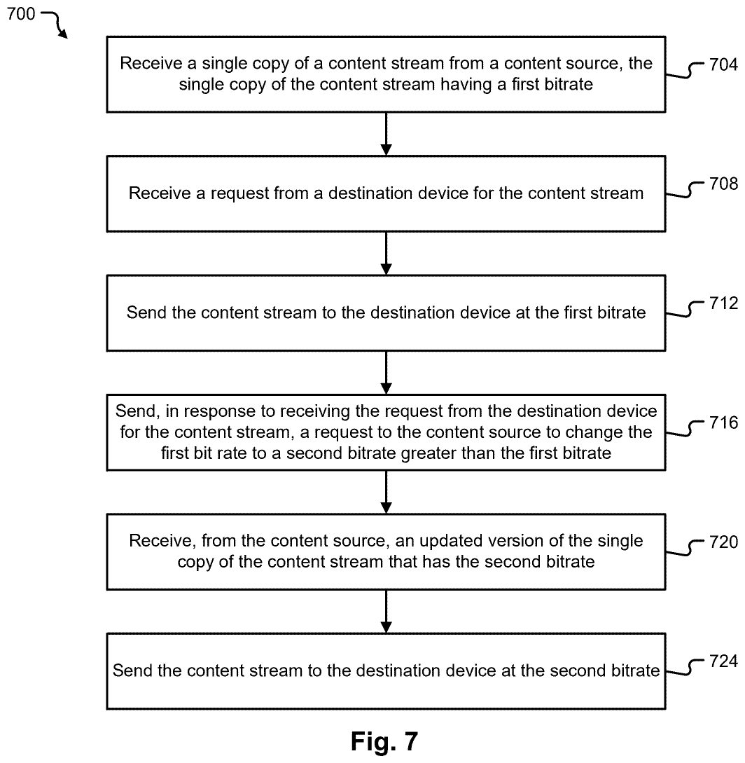

As may be appreciated, the method 600 provides efficient stream management functionality within the systems of FIGS. 1-4. Although not explicitly illustrated, the stream manager 103 may terminate the connection with a content source 101 for a particular stream if that stream is not requested by any devices within the environment 200. However, example embodiments are not limited thereto, and as described in more detail below with reference to FIG. 7, content streams may be continuously provided to the stream manager 103 even when not in use within the environment 200.

FIG. 7 illustrates a method 700 according to at least one example embodiment. Each operation in method 700 may be carried out with one or more suitable messages or signals sent over a wired and/or wireless connection by one or more elements of the systems 100a-d which may be said to include a plurality of destination devices. The method 700 may be performed by the stream manager 103 or by another element having stream manager 103 functionality. In more detail, the method 700 relates to adjusting bitrates of content streams received from content sources 101 in response to certain triggers, which may conserve bandwidth during non-peak usage and/or improve the user viewing experience at TV 107 by reducing picture and/or audio delays when switching between content streams. The method 600 may be augmented by the method 700.

Operation 704 includes receiving a single copy of a content stream from a content source 101. Operation 708 includes receiving a request from a destination device, such as a TV 107, for the content stream. Operation 712 includes sending the content stream to the destination device at a first bitrate, for example, in response to receiving the request in operation 708. For example, the stream manager 103 receives the single copy of the content stream from the content source 101, receives the request from the destination device, and sends the content stream to the destination device at the first bitrate. The first bit rate may be a rate that results in a lower quality picture/audio than is achievable by the system but that is sufficient enough for the user to determine the type of content (e.g., a sportscast, a sitcom, a talk show, etc.) being displayed or output at the destination device. In some examples, the copy of the content stream is continuously provided by the content source 101 to the stream manager 103 at the first bitrate such that the content stream is always present at the stream manager 103, which may result in the user experiencing less picture/audio delay upon requesting the content stream compared to the stream manager 103 having to retrieve the content stream from the content source 101 when requested.

In operation 716 includes the stream manager 103 sending, in response to receiving the request from the destination device for the content stream, a request to the content source 101 to change the first bit rate to a second bitrate greater than the first bitrate. Operation 720 includes receiving, by the stream manager 103 from the content source 101, an updated version of the single copy of the content stream that has the second bitrate. Thereafter, in operation 724, the stream manager 103 sends the content stream to the destination device at the second bitrate so that the content stream is presented at the destination device in accordance with the second bitrate. As may be appreciated, the second bit rate, which is greater than the first bitrate, enables the destination device to present a higher quality picture/audio to the user than when presenting the content stream at the first bitrate. For example, the second bitrate may enable the system to achieve its maximum capabilities so that the destination device outputs the highest possible quality picture and/or audio (e.g., 1080p, 4K, UHD, etc.).

The method 700 enables a system to avoid picture/audio delays when a user switches between content streams while also keeping bandwidth consumption at the stream manager 103 lower for content streams not currently being provided to users within the environment 200. When a content stream becomes active (i.e., is requested by a destination device), the content stream's bitrate is increased to provide the higher quality picture/audio at the destination device.

The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the foregoing has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

1. A system for a hospitality environment, comprising:
a plurality of destination devices; and
a first routing device in communication with the plurality of destination devices, the first routing device being configured to:
receive a request for a content stream from a first destination device of the plurality of destination devices;
determine whether the content stream is currently being provided by the first routing device to a second destination device of the plurality of destination devices;
when the content stream is currently being provided by the first routing device to the second destination device:
determine a channel assignment of the content stream being provided to the first destination device;
send the channel assignment of the content stream to the second destination device over a first network to enable the second destination device to process the content stream; and
send the content stream to the first destination device and the second destination device over a second network different than the first network; and
when the content stream is not currently being provided by the first routing device to the second destination device, forward the request for the content stream to a first network element.

2. The system of claim 1, wherein the second destination device comprises:
a display; and
a terminal to enable communication between the display and the second network.

3. The system of claim 2, wherein the request for the content stream passes through the display and the terminal.

4. The system of claim 1, wherein the second destination device further comprises:
a display; and
a set top box to enable communication between the display and the first network and between the display and the second network.

5. The system of claim 4, wherein the request for the content stream passes through the display and the set top box.

6. The system of claim 5, wherein the set top box processes the content stream for display on the display.

7. The system of claim 1, further comprising:
an amplifier positioned between the first routing device and the first destination device to amplify the content stream.

8. The system of claim 1, wherein the second destination device further comprises:
a set top box to enable communication between a display and the first network and between the display and the second network.

9. The system of claim 1, wherein the first network element is at an edge of a network that includes the first routing device the plurality of destination devices, and wherein a content source provides the content stream to the first network element.

10. The system of claim 1, wherein the first network is an IP network and the second network is an RF network.

11. The system of claim 1, wherein the first destination device comprises:
a terminal collocated that passes the request for the content stream to the first routing device.

12. The system of claim 11, wherein the first network element corresponds to a content source that provides the content stream, and wherein the first routing device is in communication with the terminal and the content source.

13. The system of claim 12, wherein the first routing device and the terminal communicate over the second network, and wherein the first routing device and the content source communicate over the second network.

14. The system of claim 13, wherein the first routing device reformats the content stream received over the second network for transmission over the first network.

15. The system of claim 14, wherein the first network is an IP network and the second network is an RF network.

16. The system of claim 11, further comprising:
a key stroke router to convert a command corresponding to the request for the content stream received from the terminal over the second network into a format for sending over the first network.

17. The system of claim 1, further comprising:
an access point that wirelessly transmits the request for the content stream to the first routing device.

18. A device for managing content streams, comprising:
memory including instructions; and
a processor that executes the instructions to:
receive a single copy of a content stream from a content source, the single copy of the content stream having a first bitrate;
receive, while the content stream is being received from the content source at the first bitrate, a request from a destination device for the content stream;
send the content stream to the destination device at the first bitrate;
send, in response to receiving the request from the destination device for the content stream and while still sending the content stream to the destination device at the first bitrate, a request to the content source to change the first bitrate to a second bitrate greater than the first bitrate;
receive, from the content source, an updated version of the single copy of the content stream that has the second bitrate; and
send the content stream to the destination device at the second bitrate.

19. The device of claim 18, wherein the memory includes instructions that when executed by the processor cause the processor to reformat the content stream from the content source for routing to the destination device.

20. A device for managing content streams, comprising:
memory including instructions; and
a processor that executes the instructions to:
receive a request for a content stream from a first destination device of a plurality of destination devices;
determine whether the content stream is currently being provided by the first routing device to a second destination device of the plurality of destination devices;
when the content stream is currently being provided by the first routing device to the second destination device:
determine a channel assignment of the content stream being provided to the first destination device;
send the channel assignment of the content stream to the second destination device over a first network to enable the second destination device to process the content stream; and
send the content stream to the first destination device and the second destination device over a second network different than the first network; and
when the content stream is not currently being provided by the first routing device to the second destination device, forward the request for the content stream to a first network element.
